(19) United States
(12) Patent Application Publication
(10) Pub. No.: US 2024/0034195 A1
(43) Pub. Date: Feb. 1, 2024

(54) POWERTRAIN FOR A WORK MACHINE, METHOD FOR OPERATING THE POWERTRAIN, AND WORK MACHINE

(71) Applicant: ZF FRIEDRICHSHAFEN AG, Friedrichshafen (DE)

(72) Inventor: Juergen Legner, Friedrichshafen (DE)

(21) Appl. No.: 18/257,313

(22) PCT Filed: Dec. 8, 2021
(86) PCT No.: PCT/EP2021/084725

§ 371 Date: Jun. 14, 2023

(30) Foreign Application Priority Data
Dec. 18, 2020 (DE) 10 2020 216 265.4

(51) Int. Cl. B60L 58/27; F16H 57/04; B60K 1/02; B60L 50/60

(52) U.S. Cl. CPC B60L 58/27; F16H 57/0415; F16H 57/0436; B60K 1/02; B60L 50/60; B60K 2001/008

(57) ABSTRACT

A powertrain for a work machine, including at least one electric motor, an electric energy store, a multi-stage manual transmission, a heating circuit, and a cooling circuit. The at least one electric motor is configured to provide a mechanical input power. The manual transmission is configured to convert the mechanical input power and provide it as mechanical output power. The energy store is configured to supply the at least one electric motor and the heating circuit with electric power. The heating circuit is configured to provide a heating fluid for heating the energy store. The cooling circuit is configured to provide a cooling fluid for cooling and lubricating the manual transmission. The heating circuit and the cooling circuit are coupled via a heat exchanger and have only a single joint cooling device.

### CROSS REFERENCE TO RELATED APPLICATIONS

This application is a U.S. National Phase application under 35 U.S.C. § 371 of International Application No. PCT/EP2021/084725, filed on Dec. 8, 2021, and claims benefit to German Patent Application No. DE 10 2020 216 265.4, filed on Dec. 18, 2020. The International Application was published in German on Jun. 23, 2022 as WO 2022/128668 A1 under PCT Article 21(2).

### FIELD

The present invention relates to a powertrain for a work machine, a method for operating a powertrain of a work machine and a corresponding work machine.

### BACKGROUND

In the prior art, electrically driven work machines, such as wheel loaders, compact loaders, telescopic loaders, dumpers or excavators, are known. These electrically driven work machines are either purely electrically driven, i.e. they have exclusively an electric battery or an electric accumulator for their energy supply, or they are diesel-electrically driven, which means that the required energy is provided by a diesel-driven generator, usually in connection with an electrical buffer storage, such as e.g. a correspondingly dimensioned capacitor. In all cases, the mechanical power required for the travel drive and the working drive is provided by one or more electric motors. Furthermore, hybrid-electric work machines are also known, in which the mechanical power required for operation is primarily provided by an internal combustion engine, usually a diesel engine. An additionally provided electric motor is powered by a battery or an accumulator and typically takes on a so-called boost function here.

In this context, DE 20 2014 000 738 U1 describes a purely electric-motor-driven wheel loader, which has a first electric motor for a travel drive and a second electric motor for a working drive.

The electric battery is usually formed as a Li-ion battery since such batteries can provide a comparatively large energy content at a comparatively low weight. The preferred operating temperature of these batteries is approximately between 20° C. and 30° C. In particular, at ambient temperatures below freezing point, it is necessary to first heat the battery to operating temperature in order to avoid damage to the battery.

For example, it is therefore known from DE 10 2011 076 737 A1 to couple the battery with a heat transfer arrangement and to supply it with the amount of heat required for damage-free operation before it is put into service.

DE 10 2009 022 300 A1 describes a vehicle with an electric drive, comprising an electric energy store and a heat store. The heat store can be supplied with waste heat generated during operation of the drive or when charging the energy store for storage. Later, this heat can be removed again to heat components coupled to the heat store as required, for example, the passenger compartment or drive components.

It is also known that manual transmissions, in particular multi-stage manual transmission, in powertrains of motor vehicles must be lubricated and cooled by means of a suitable lubricant and coolant agent such as, for example, transmission oil, for example, in order to avoid overheating and resulting damage or destruction.

DE 10 2019 217 494.9 of the applicant which is still unpublished describes a hydraulic control unit of a shiftable synchromesh transmission which at low ambient temperatures prior to being put in service is preheated via one or more heating cartridges so that the synchromesh transmission can be reliably shifted from the start.

The known electrically driven work machines are disadvantageous in that they require a comparatively complex and powerful stepped transmission, in contrast to electrically driven passenger cars—despite the comparatively wide speed range of electric motors—in order to meet all work requirements. In particular, clutches or valves within the stepped transmission are, however, only fully functional if the fluid used for their actuation has reached a required minimum viscosity. The fluid is generally usually a transmission oil, which is also used for cooling and lubricating the transmission. However, due to the lack of waste heat from an internal combustion engine and the high efficiency of the electric drive and the also low mechanical friction losses in the stepped transmission, the amount of heat required for this can often only be provided after a certain operating period. Until then, the work machine is only limited in its usability.

### SUMMARY

In an embodiment, the present disclosure provides a powertrain for a work machine, comprising at least one electric motor, an electric energy store, a multi-stage manual transmission, a heating circuit, and a cooling circuit. The at least one electric motor is configured to provide a mechanical input power. The manual transmission is configured to convert the mechanical input power and provide it as mechanical output power. The energy store is configured to supply the at least one electric motor and the heating circuit with electric power. The heating circuit is configured to provide a heating fluid for heating the energy store. The cooling circuit is configured to provide a cooling fluid for cooling and lubricating the manual transmission. The heating circuit and the cooling circuit are coupled via a heat exchanger and have only a single joint cooling device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an embodiment of a powertrain for a work machine.

### DETAILED DESCRIPTION

In an embodiment, the present invention provides an improved powertrain for a work machine.

An embodiment of the invention relates to a powertrain for a work machine, comprising at least one electric motor, an electric energy store, a multi-stage manual transmission, a heating circuit and a cooling circuit, wherein the at least one electric motor is formed to provide a mechanical input power, wherein the manual transmission is formed to convert the mechanical input power and provide it as mechanical output power, wherein the energy store is formed to supply the at least one electric motor and the heating circuit with electric power, wherein the heating circuit is formed to provide a heating fluid for heating the energy store and wherein the cooling circuit is formed to provide a cooling fluid for cooling and lubricating the manual transmission. The powertrain according to an embodiment of the invention is characterized in that the heating circuit and the cooling circuit are coupled via a heat exchanger and have only a single joint cooling device.

An embodiment of the invention therefore provides a powertrain which is suitable for driving a work machine. Since work machines must generally operate most of the time under high drive loads and in particular in absolute terms must deliver comparatively high performance, the powertrain according to an embodiment of the invention differs in terms of its design, for example, from a car powertrain which is typically operated in a load range of 5% to 10% of the maximum power and in particular absolutely delivers lower performance.

The powertrain according to an embodiment of the invention comprises at least one electric motor. Since a work machine usually also requires at least one work drive in addition to a travel drive, the at least one electric motor can equally be assigned to the travel drive and the at least one working drive.

The powertrain preferably comprises, however, two or more electric motors, of which in each case at least one electric motor is assigned to the travel drive and at least one further electric motor is assigned to the working drive.

The at least one electric motor is preferably a so-called asynchronous motor.

The at least one electric motor can, according to a control input, be provided with an electric power actuation, wherein the power actuation is dependent on a predefinable electrical voltage actuation of the at least one electric motor and represents a measure for the electrical power supplied to the at least one electric motor. The at least one electric motor drives the powertrain or the travel drive or the working drive.

A control input for the powertrain or for the travel drive or for the working drive is understood, for example, as a desired acceleration of the work machine or a desired raising of a loaded bucket. Such a control input has the result that the powertrain must provide the mechanical power required to implement the control input. It is irrelevant here whether the control input is performed by means of an input of an operator of the work machine, e.g. by actuation of an accelerator driving pedal or an operating joystick, or by means of an automated control intervention of an assistance system of the work machine.

The powertrain furthermore comprises a multi-stage manual transmission, in particular a synchromesh transmission which converts a mechanical input power provided by the at least one electric motor in terms of its rotational speed and its torque according to a selected gear stage. Although electric motors have a relatively large speed range from zero to approx. 20,000 rpm in comparison with internal combustion engines, in particular a comparatively high resultant torque can be generated by using a manual transmission and a corresponding rotational speed transmission, which is highly advantageous for the operation of a work machine since comparatively heavy work can thus also be performed.

This advantageously involves a manual transmission which can be shifted under load.

The powertrain furthermore also comprises a cooling circuit with a cooling fluid for cooling and lubricating the manual transmission. As a result of this, on one hand, the wear of the manual transmission is reduced and, on the other hand, the efficiency of the manual transmission is increased. The cooling fluid can be, for example, a transmission oil which is stored as an oil sump in an oil pan and is conveyed by a pump at lubrication points of the manual transmission. The pump can be operated electrically or driven by a shaft of a manual transmission or the at least one electric motor. The cooling fluid is advantageously also used to actuate clutches of the manual transmission.

The cooling circuit advantageously also comprises a compensating reservoir in order to ensure volume compensation in the case of a temperature-induced change in volume of the cooling fluid. An oil sump of the manual transmission is particularly preferably used as a compensating reservoir.

The powertrain furthermore comprises a heating circuit with a heating fluid for heating the energy store which is also encompassed by the powertrain. The heating of the energy store to a temperature of advantageously at least 10° C., in particular at least 15° C. before the powertrain is put into service protects the energy store from damage. The energy for heating the energy store by means of the heating circuit also originates from the energy store, but only comparatively small electrical power or currents are required for this which can be removed therefrom without any danger and without the risk of irreparable damage to the energy store. The electrical power or currents required to operate the at least one electric motor are in contrast disproportionately larger and should not be removed from the energy store as long as it is still below a suitable operating temperature. The heating circuit thus gains significance above all after longer downtimes of the work machine at low ambient temperatures.

The heating fluid is advantageously a water mixture, in particular a glycol-water mixture.

The heating circuit preferably comprises a heating device which can heat the heating fluid. The heating device is advantageously formed as a heating coil which is in physical contact with the heating fluid, in particular is immersed into the heating fluid. A heating coil is comparatively low-cost and robust.

During continuous operation of the powertrain and in particular in the case of permanently high removal of current from the energy store, it can occur that the energy store reaches such a high temperature that, in an analogous manner to an excessively low temperature, there is a risk of damage to the energy store as a result of the high temperature. In this case, the heating device can advantageously be deactivated so that the heating circuit for the energy store takes on a cooling function, i.e. discharges heat from the energy store.

The heating circuit furthermore also preferably comprises a compensating reservoir in order to ensure volume compensation in the case of a temperature-induced change in volume of the heating fluid.

The powertrain, as described, furthermore comprises an electrical energy store which is preferably formed as a rechargeable Li-ion battery. Li-ion batteries are comparatively temperature-sensitive, i.e. they have available their maximum performance only in a comparatively narrow temperature range from approximately 20° C. to approximately 30° C. In particular at temperatures below the freezing point, they are greatly restricted in terms of the maximal electrical power which can be taken up or provided. In the case of temperatures which significantly diverge from their ideal operating temperatures, irreversible damage of the Li-ion batteries can furthermore also occur if the removed or supplied electrical currents exceed a current threshold which is not critical and comparatively low in normal circumstances. Li-ion batteries according to the current prior art are nevertheless best suited to operation of the powertrain as a result of their comparatively high energy density and their comparatively low weight.

The energy store stores electrical energy which can be made available for the operation of the at least one electric motor and the heating circuit. In particular, the electrical energy can also be made available to operate further electrical consumers, such as, for example, pumps, valves, computing units, air-conditioning devices in the driver's cabin, displays, lights or headlamps. Heat loss occurs in accordance with the internal resistance of the energy store and the application of current to the energy store which leads over time to a heating up of the energy store both during removal of electrical energy and during the supply of electrical energy, i.e. during charging or the energy store. Due to the comparatively low internal resistance, the heat loss is, however, comparatively low.

It is thus provided according to an embodiment of the invention that the heating circuit and the cooling circuit are coupled via a heat exchanger. I.e. therefore that the heating circuit and the cooling circuit are thermally coupled. The term “thermally coupled” is understood within the meaning of embodiments of the invention such that the heating circuit and the cooling circuit are in physical contact with one another so that an exchange of heat can occur between them without physical contact in the sense of a mixing of the heating fluid with the cooling fluid arising. The heat exchanger is preferably formed to be metallic and has a comparatively large surface.

For example, the heating fluid can be conveyed through metallic pipelines which run within an oil sump which stores the cooling fluid formed as transmission oil. An effective thermal coupling between the two fluids can thus be produced via the metallic pipelines without a physical mixing through occurring. The pipelines can preferably also have cooling ribs. In this case, the heat exchanger is therefore formed as an oil sump of the manual transmission with the pipelines which conduct the heating fluid.

It is, however, also conceivable to provide the heat exchanger as an independent device separate from the oil sump. In this case too, the heating fluid is preferably also conducted through metallic pipelines, in particular pipelines with cooling ribs, through a reservoir of the cooling fluid located in the heat exchanger or vice versa. A where necessary controllable volumetric flow of the heating fluid or cooling fluid is advantageously conducted both through the reservoir and through the pipelines. The higher the respective volumetric flow, the greater the heat exchange which takes place.

The advantage arises from the thermal coupling of the heating circuit with the cooling circuit that the heat required to put into service the energy store—at least in the case of longer downtimes of the work machine in cold surroundings—can be conducted onto the cooling circuit in order to also heat up the cooling fluid for the manual transmission. A viscosity of the cooling fluid is specifically generally largely dependent on the temperature of the cooling fluid so that valves and clutches of the manual transmission are often initially difficult or impossible to actuate since they are blocked by the cold cooling fluid and its excessively high viscosity. Embodiments of the invention thus advantageously makes it possible to put the work machine back into service without delay with a fully functional range even after long downtimes in a cold environment. The required heat can be generated at any time as required. A comparatively heavy heat store which is installed in the work machine is advantageously not required.

An embodiment of the invention uses the knowledge that a cooling function is indeed assigned to the cooling circuit which, however, does not lead to a cooling of the manual transmission or the cooling fluid below the ambient temperature as a result of the cooling performed by the cooling circuit. On the contrary, the cooling circuit is supposed to prevent a predefinable maximum temperature of the manual transmission or of the cooling fluid being exceeded, wherein this maximum temperature lies significantly above the ambient temperature. In this regard, an embodiment of the invention has recognized that heating the cooling circuit to a certain degree is advantageous as long as the temperature generated in this case lies below the predefinable maximum temperature.

It is furthermore provided according to an embodiment of the invention that the heating circuit and the cooling circuit only have a single joint cooling device. Since the heating circuit and the cooling circuit are thermally coupled via a heat exchanger, i.e. a thermal discharge from the respectively warmer circuit into the respectively colder circuit is performed, a separate cooling device for each individual circuit, i.e. the heating circuit or the cooling circuit, can advantageously be dispensed with. A cooling device can thus advantageously be saved in comparison with the prior art, which reduces the material outlay and the cost outlay for the powertrain according to an embodiment of the invention.

The cooling device is formed in particular as a metallic cooling body with cooling ribs as well as advantageously with one or more fans which generate a laminar air flow along the cooling ribs. The heat to be discharged can thus be efficiently released to the surroundings.

According to a preferred embodiment of the invention, it is provided that the joint cooling device is assigned to the heating circuit. Here, an embodiment of the invention uses the knowledge that the heating circuit, despite the fact that it serves above all to heat the energy store, nevertheless has in continuous operation a lower nominal temperature than the cooling circuit which serves to cool the manual transmission. Once the respective nominal temperature has been reached, heat can thus be discharged from the cooling circuit via the heat exchanger to the heating circuit and released from this via the cooling device to the surroundings. The cooling of the cooling fluid is therefore performed via the heat exchanger.

According to a preferred embodiment of the invention, it is provided that the at least one electric motor is connected to the heating circuit. The advantage arises from this that waste heat from the at least one electric motor can be used to heat the heating circuit. Although the at least one electric motor generally has an efficiency of more than 95%, it is nevertheless reliant on active cooling to prevent damage as a result of overheating. In particular in continuous operation the at least one electric motor can undergo significantly heating, as a result of which in turn its electrical resistance is increased and it consequently experiences even more pronounced heating. Cooling of the electric motor can prevent or at least reduce this negative effect. By virtue of the fact that the heat discharged from the at least one electric motor is now used to heat the heating fluid, the heating power to be provided by the heating device can advantageously be reduced. This reduces the overall energy consumption of the powertrain according to an embodiment of the invention and increases its efficiency.

Insofar as more than only one electric motor is provided, for example, an electric motor for the travel drive and an electric motor for the working drive, all of the electric motors are thus advantageously thermally coupled with the heating circuit.

According to a preferred embodiment of the invention, it is provided that a power electronics unit of the at least one electric motor is connected to the heating circuit. Just like the at least one electric motor, the power electronics unit also generates waste heat as a function of a current strength switched by it and in accordance with its internal resistance, which waste heat must be discharged in order to avoid thermal damage to the power electronics unit. By virtue of the fact that this waste heat is supplied to the heating circuit, the heating power to be provided by the heating device can advantageously be yet further reduced. This also contributes to reducing the overall energy consumption and increasing the efficiency of the powertrain according to an embodiment of the invention.

According to a preferred embodiment of the invention, it is provided that the heating fluid is supplied in the direction of flow from the heating device initially to the energy store and subsequently to the power electronics unit before it is supplied to the at least one electric motor. By virtue of the fact that the heating fluid is supplied first to the energy store, it can discharge the majority of its thermal energy to the energy store there and heat it to a required operating temperature. Once the heating fluid has discharged the majority of its thermal energy to the energy store, i.e. has been cooled by the energy store, it is now supplied to the power electronics unit which, for fault-free operation, is not reliant on a particular minimum temperature. In contrast, the power electronics unit generally composed of semiconductor switching elements generally operates even more effectively and with fewer faults because it has a low temperature. In this regard, the heating fluid, once it has been cooled by the energy store, can ensure a cooling function for the power electronics unit. If the heating fluid is subsequently supplied to the at least one electric motor, it can also take on a cooling function for the at least one electric motor. The heat input by the power electronics unit into the heating fluid is namely comparatively small, hence the heating fluid will generally have a significantly lower temperature than the at least one electric motor, in particular in continuous operation of the at least one electric motor. The cooling of the at least one electric motor not only improves its efficient, but ultimately also prevents damage by overheating of the at least one electric motor. The heating fluid can be conducted from the at least one electric motor initially via the cooling device before it is supplied to the energy store. Account is thus taken of the fact that the energy store on one hand requires a specific minimum temperature for reliable and damage-free operation, on the other hand, however, should also not be operated above a maximum temperature since damage could otherwise also occur to the energy store.

Alternatively, it is preferably provided that the heating fluid is supplied in the direction of flow from the heating device initially to the power electronics unit and subsequently to the energy store before it is supplied to the at least one electric motor. As a result, additional thermal energy from the power electronics unit can be absorbed into the heating fluid and supplied directly to the energy store.

It is preferably provided that the heating fluid is supplied to the joint cooling device once it has been conducted to the at least one electric motor. In particular during continuous operation of the powertrain, the at least one electric motor represents the largest heat source in the heating circuit. The temperature of the heating fluid—insofar as it is higher than a temperature which is suitable for operation of the energy store—can thus be cooled again by the release of heat to the surroundings.

According to a preferred embodiment of the invention, it is provided that the heating circuit comprises at least one hydraulic directional valve via which the direction of flow from the heating device can be adjusted in such a manner that, according to a state of the at least one hydraulic flow control valve, the heating fluid is supplied initially to the energy store and subsequently to the power electronics unit or initially supplies the power electronics unit and subsequently the energy store. Depending on the degree to which the energy store must still be heated to reach the nominal temperature, the heating fluid can therefore be conducted directly to the energy store or via the power electronics unit to the energy store.

According to a preferred embodiment of the invention, it is provided that the heating circuit and/or the cooling circuit comprises at least one hydraulic separating valve via which the heat exchanger can be hydraulically separated from the heating circuit and/or from the cooling circuit so that no heat exchange occurs any more between the heating circuit and the cooling circuit. The advantage arises from this that the cooling circuit can be separated from the heating circuit, for example, in the case of a stationary working mode of the work machine. Since the manual transmission is exclusively required for driving and can remain in the idle state in the stationary working mode, the cooling circuit can in this case be separated from the heating circuit via the separating valve. It is thus also avoided that the cooling circuit is cooled via the heating circuit and no longer had the optimal operating temperature in the case of renewed putting into service.

According to a preferred embodiment of the invention, it is provided that the heating circuit comprises at least one hydraulic bypass valve via which the joint cooling device can be hydraulically bypassed. The required heat supply for the energy store and for the manual transmission can thus be provided comparatively quickly precisely in the case of an initial putting into service after a longer downtime of the work machine, in particular in a comparatively cold environment, since a discharge of heat via the cooling device to the surroundings can be avoided by bypassing the cooling the cooling device. Instead, all of the heat supplied to the heating circuit is retained within the heating circuit or cooling circuit until all the components of the powertrain have reached the required operating temperatures.

According to a preferred embodiment of the invention, it is provided that the heating circuit and/or the cooling circuit comprise in each case a feed pump. The feed pump of the heating circuit and the feed pump of the cooling circuit ensure in this case a flow of the heating fluid in the heating circuit or of the cooling fluid in the cooling circuit. Since the heat is transported in each case via the heating fluid or the cooling fluid, the thermal transport is therefore ultimately enabled via the feed pumps.

The feed pump of the heating circuit or the feed pump of the cooling circuit is preferably controllable. The volumetric flow strength in the heating circuit and in the cooling circuit can thus be controlled and thus the thermal transport in the heating circuit and in the cooling circuit can also be controlled.

It is furthermore preferred that the feed pump of the heating circuit and the feed pump of the cooling circuit are formed as electric pumps, i.e. that they have in each case an electric motor provided for their operation.

Alternatively, the feed pump of the heating circuit and the feed pump of the cooling circuit are preferably driven via a mechanical shaft and possibly via a transmission ratio by the at least one electric motor.

An embodiment of the invention furthermore relates to a method for operating a powertrain for a work machine, wherein the powertrain comprises at least one electric motor, an electric energy store, a multi-stage manual transmission, a heating circuit and a cooling circuit, wherein a mechanical input power is provided by the at least one electric motor, wherein the mechanical input power is converted into a mechanical output power by the manual transmission, wherein the at least one electric motor and the heating circuit are supplied with electrical power by the energy store, wherein a heating fluid for heating the energy store is heated by the heating circuit and wherein a cooling fluid for cooling and lubricating the manual transmission is cooled by the cooling circuit. The method according to an embodiment of the invention is characterized in that the cooling circuit is heated by the heating circuit in a situation-dependent manner via a heating device or is cooled via a cooling device. Advantages already described in conjunction with the powertrain according to embodiments of the invention arise from this.

According to a preferred embodiment of the invention, it is provided that the heating fluid is supplied in the direction of flow from the heating device of the heating circuit initially to the energy store and subsequently to the power electronics unit if a temperature of the power electronics unit is lower than a temperature of the energy store and that the heating fluid is supplied in the direction of flow from the heating device of the heating circuit initially to the power electronics unit and subsequently to the energy store if the temperature of the power electronics unit is higher than the temperature of the energy store. The advantage emerges from this that, depending on the situation, the waste heat of the power electronics unit can be used to heat the energy store insofar as it has to be heated further or that the waste heat of the power electronics unit can be supplied to the cooling device insofar as the energy store has already reached its operating temperature or possibly must even be cooled.

According to a preferred embodiment of the invention, it is provided that heating fluid and cooling fluid are conveyed through the heat exchanger if the energy store is being charged. During charging of the energy store, the work machine is normally not in operation since it is connected to a charge point by a required charging cable for power supply and can thus not be moved. As a result, the at least one electric motor and the stepped transmission are also in the idle state, therefore do not produce any waste heat, so that the cooling fluid gradually discharges its heat to the surroundings and cools. Since, however, electrical losses in the form of waste heat at the energy store arise at the same time as a result of the charging process, the waste heat generated by the charging can be passed onto the heating fluid and via the heat exchanger from the heating fluid to the cooling fluid as a result of the thermal coupling of the heating circuit and the cooling circuit via the heat exchanger during the charging process, so that the cooling fluid does not completely cool and the work machine can be put into service immediately after the charging process without an otherwise necessary heating up of the cooling fluid. As a result of this active cooling of the energy store, this can furthermore be charged with comparatively higher currents, which advantageously shortens the charging process.

An embodiment of the invention furthermore relates to a work machine, comprising a powertrain according to the invention. The advantages already described in the context of the powertrain according to embodiments of the invention also arise from this for the work machine according to an embodiment of the invention.

It is preferably provided that the work machine is formed as a wheel loader, dumper, excavator, telescopic loader, municipal vehicle, garbage truck, mining vehicle, skid steer loader, aircraft tug or tractor.

Embodiments of the invention are explained below by way of example on the basis of embodiments represented in the figure.

Identical objects, functional units and comparable components are designated by the same reference numbers across the figures. These objects, functional units and comparable components are embodied to be identical in terms of their technical features, insofar as something else does not emerge explicitly or implicitly from the description.

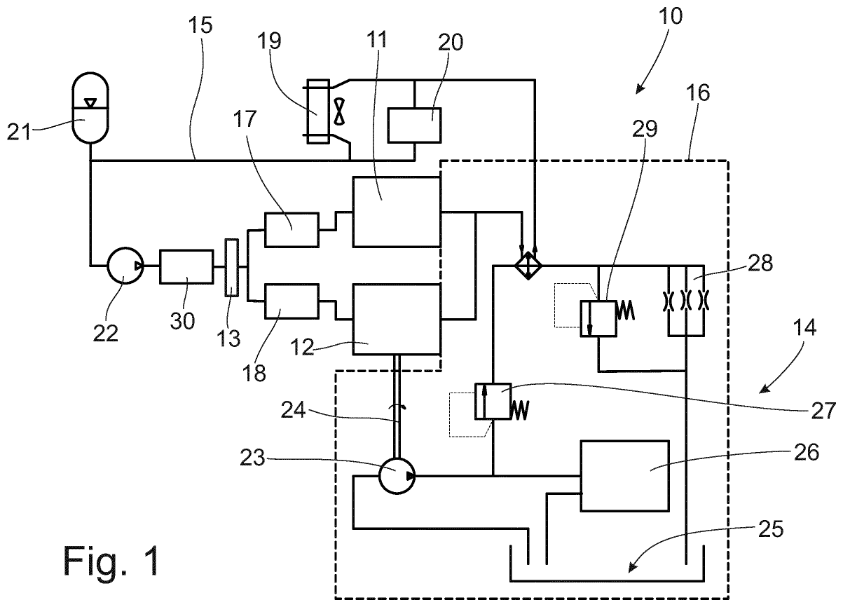

FIG. 1 shows by way of example and schematically one possible embodiment of a powertrain 10 according to an embodiment of the invention for a work. The powertrain 10 comprises by way of example two electric motors 11, 12, wherein an electric motor 11 is assigned to a travel drive and an electric motor 12 is assigned to a working drive. The powertrain 10 furthermore comprises an electrical energy store 13 formed as a rechargeable Li-ion battery 13, which electrical energy store 13 is formed to supply the electric motors 11, 12 with electrical power. The electric motors 11, 12 are themselves formed to provide in each case a mechanical input power via their motor shafts. The input power of the electric motor 11 assigned to the travel device is supplied to a multi-stage manual transmission 14 which is formed as a synchromesh transmission which can be shifted under load. The manual transmission 14 converts the mechanical input power and provides a mechanical output power which can be used to drive drivable vehicle wheels or drivable axles of the work machine. The input power of the electric motor 13 assigned to the working drive is in contrast supplied to a hydraulic working drive and is converted by it into a hydraulic volumetric flow and a hydraulic pressure and is thus output again as hydraulic output power.

The powertrain 10 furthermore comprises a heating circuit 15 which is formed to provide a heating fluid for heating the energy store 13 as well as a cooling circuit 16 which is formed to provide a cooling fluid for cooling and lubricating the manual transmission 14. The heating circuit 15 furthermore also comprises a heating device 16 which is formed, for example, as a heating coil 16 and is arranged directly in front of the energy store 13 in the direction of flow of the heating fluid. The heating circuit 16 furthermore comprises two power electronics units 17 and 18 of which in each case one is assigned to one of electric motors 11 and 12. The electric motors 11 and 12 are also thermally connected to the heating circuit 16. The heating fluid is conducted from the electric motors 11 and 12 further to a heat exchanger 31 which is formed, for example, as a reservoir for the heating fluid through which metallic pipelines with cooling ribs pass, wherein the cooling fluid is conducted through the pipelines. The heat exchanger 31 thus represents a thermal coupling between the heating circuit 15 and the cooling circuit 16. A metallic cooling device 19 with cooling ribs and a fan follows on from the heat exchanger 31 in the direction of flow of the heating fluid. The cooling device 19 can be bypassed by a bypass valve 20 so that the heating circuit does not discharge any heat to the surroundings. The heating circuit 15 furthermore comprises a compensating reservoir 21 in order to compensate for temperature-induced changes in volume of the heating fluid in the heating circuit as well as an electrically driven feed pump 22.

The cooling circuit 16 also comprises a feed pump 23 which, by way of example, is, however, driven mechanically via a shaft 24 by the electric motor 12. The feed pump 23 conveys cooling fluid, which is formed by way of example as transmission oil, from an oil sump 25 of the manual transmission 14 and supplies it to a hydraulic clutch control 26 of the manual transmission 14. The feed pump 23 furthermore conveys cooling fluid via a branch in the cooling circuit 16 to a system pressure-limiting valve 27. The cooling fluid travels from the system pressure-limiting valve 27 to the heat exchanger 31, where heat exchange with the heating fluid occurs. The cooling fluid is supplied from the heat exchanger 31 to the elements 28 of the manual transmission 14 to be lubricated and cooled. By way of example, elements 28 to be lubricated and cooled involve a plurality of gear wheels. The volumetric flow of cooling fluid supplied to the elements 28 to be lubricated and cooled can be controlled via a control valve 29.

When the powertrain 10 is put into service after a longer downtime in a cool environment, both the energy store 13 and the transmission oil have assumed the ambient temperature. The has the result that the energy store 13 can initially only provide small currents without suffering damage. The transmission oil is furthermore still too viscous to be able to actuate the clutch control 26. The heating fluid can thus be preheated via the heating device 30 and transported by the feed pump 22 to the energy store 13 in order to heat it quickly to a required operating temperature. At the same time, the heating fluid comes into thermal contact with the cooling fluid via the heat exchanger 31 so that the cooling fluid is also heated and is heated quickly. As a result of the heating of the cooling fluid, its viscosity is reduced and enables fault-free operation of the clutch control 26.

After a certain period of operation, the cooling fluid has reached its nominal temperature which is, by way of example, 90° C. The energy store has likewise reached its nominal temperature which is, by way of example, 30° C. Since electrical losses inevitably arise in the energy store 13 as a result of the continuing operation of the powertrain 10 and mechanical losses arise in the manual transmission 14, which lead in each case to further heating, the heat which arises from now must be discharged via the joint cooling device 19 to the surroundings. For this purpose, the cooling fluid thus discharges heat to the heating fluid via the heat exchanger 31. The heating fluid thus also satisfies a cooling function for the energy store 13, the power electronics units 17 and 18 as well as the electric motors 11 and 12. The heating device 16 is now deactivated. The heating fluid then discharges the heat absorbed from the energy store 13 and the heat absorbed by the cooling fluid via the cooling device 19 to the surroundings.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMBERS

10 Powertrain
11 Electric motor
12 Electric motor
13 Electric energy store
14 Manual transmission
15 Heating circuit
16 Cooling circuit
17 Power electronics unit
18 Power electronics unit
19 Cooling device
20 Bridging valve
21 Compensating reservoir
22 Feed pump
23 Feed pump
24 Shaft
25 Oil sump
26 Clutch control
27 System pressure-limiting valve
28 Elements to be lubricated and cooled
29 Control valve
30 Heating device
31 Heat exchanger

1. A powertrain for a work machine, comprising:
at least one electric motor;
an electric energy store;
a multi-stage manual transmission;
a heating circuit; and
a cooling circuit,
wherein the at least one electric motor is configured to provide a mechanical input power,
wherein the manual transmission is configured to convert the mechanical input power and provide it as mechanical output power,
wherein the energy store is configured to supply the at least one electric motor and the heating circuit with electric power,
wherein the heating circuit is configured to provide a heating fluid for heating the energy store,
wherein the cooling circuit is configured to provide a cooling fluid for cooling and lubricating the manual transmission, and
wherein the heating circuit and the cooling circuit are coupled via a heat exchanger and have only a single joint cooling device.

2. The powertrain as claimed in claim 1,
wherein the joint cooling device is assigned to the heating circuit.

3. The powertrain as claimed in claim 1,
wherein the at least one electric motor is connected to the heating circuit.

4. The powertrain as claimed in claim 1,
wherein a power electronics unit of the at least one electric motor is connected to the heating circuit.

5. The powertrain as claimed in claim 1,
wherein a heater is assigned to the heating circuit.

6. The powertrain as claimed in claim 4,
wherein the heating fluid is supplied in a direction of flow from the heater initially to the energy store and subsequently to the power electronics unit before it is supplied to the at least one electric motor.

7. The powertrain as claimed in claim 6,
wherein the heating circuit comprises at least one hydraulic directional valve via which the direction of flow from the heater can be adjusted in such a manner that, according to a state of the at least one hydraulic flow control valve, the heating fluid is supplied initially to the energy store and subsequently to the power electronics unit or initially supplies the power electronics unit and subsequently the energy store.

8. The powertrain as claimed in claim 1,
wherein the heating circuit and/or the cooling circuit comprises at least one hydraulic separating valve via which the heat exchanger can be hydraulically separated from the heating circuit and/or from the cooling circuit so that no heat exchange occurs any more between the heating circuit and the cooling circuit.

9. The powertrain as claimed in claim 1,
wherein the heating circuit comprises at least one hydraulic bypass valve via which the joint cooling device can be hydraulically bypassed.

10. The powertrain as claimed in claim 1,
wherein the heating fluid is a water mixture and the cooling fluid is a transmission oil.

11. The powertrain as claimed in claim 1,
wherein the heating circuit and/or the cooling circuit comprise in each case a feed pump.

12. A method for operating a powertrain for a work machine, wherein the powertrain comprises at least one electric motor, an electric energy store, a multi-stage manual transmission, a heating circuit and a cooling circuit, the method comprising:
providing a mechanical input power is provided by the at least one electric motor;
converting the mechanical input power is converted into a mechanical output power by the manual transmission;
supplying the at least one electric motor and the heating circuit with electrical power by the energy store;
heating a heating fluid for heating the energy store is heated by the heating circuit and;
cooling a cooling fluid for cooling and lubricating the manual transmission by the cooling circuit, and
heating the cooling circuit by the heating circuit in a situation-dependent manner via a heater or via a cooler.

13. The method as claimed in claim 12,
wherein the heating fluid is supplied in a direction of flow from a heater of the heating circuit initially to the energy store and subsequently to a power electronics unit if a temperature of the power electronics unit is lower than a temperature of the energy store and
wherein the heating fluid is supplied in the direction of flow from the heater of the heating circuit initially to the power electronics unit and subsequently to the energy store if the temperature of the power electronics unit is higher than the temperature of the energy store.

14. The method as claimed in claim 12, comprising
conveying heating fluid and cooling fluid through the heat exchanger if the energy store is being charged.

15. A work machine, comprising the powertrain as claimed in claim 1.
